(19) United States
(12) Patent Application Publication
(10) Pub. No.: US 2025/0136058 A1
(43) Pub. Date: May 1, 2025

(54) WINDSHIELD DEICING SYSTEM AND CONTROL

(71) Applicant: FCA US LLC, Auburn Hills, MI (US)

(72) Inventors: Sreekanth Surapaneni, Oakland Township, MI (US); Uday Kiran Mahakali, Novi, MI (US)

(21) Appl. No.: 18/498,541

(22) Filed: Oct. 31, 2023

(51) Int. Cl. B60S 1/54; B60H 1/00

(52) U.S. Cl. CPC B60S 1/548; B60H 1/00785; B60S 1/544

(57) ABSTRACT

There is provided a system and method for monitoring snow or ice accumulation on a vehicle window by a user with a mobile device. The system includes a camera directed to at least a portion of a window in the vehicle. The system further comprises a heating element, a blower and vents. Images from the camera may be sent to a mobile device that can be displayed on a screen. These images can be used to determine the presence of snow or ice, and the amount of clearing of snow or ice that has been achieved after activation of the system.

### FIELD

The present disclosure relates to a windshield deicing system and control.

### BACKGROUND

During cold days, vehicles parked in the open often accumulate snow or ice on their windshields. Such snow or ice accumulation can be cleared by a user in the car selecting the defrost mode of the HVAC (Heating, Ventilating, and Air Conditioning) system. Currently, snow or ice presence on the windshield could only be determined by a user viewing the vehicle in-person. Such methods can be inconvenient in the cold weather. Furthermore, remotely starting a vehicle can help to reduce snow or ice as the vehicle warms-up, but can result in excess vehicle operation. During the interval between the user checking the status, the snow or ice can be cleared yet the vehicle engine or batteries would continue to operate until the user of the vehicle arrives. This unnecessarily consumes fuel, or charge during the time interval after the snow or ice has been cleared and when the user of the vehicle arrives.

### SUMMARY

In at least some implementations, there is provided a system for monitoring snow or ice accumulation on a vehicle window. The system comprises a camera adapted to be directed toward a vehicle window and adapted to view at least a portion of the vehicle window. The camera is further adapted to capture images of the vehicle window. The system further comprises a blower adapted to blow air onto the vehicle window. The system further comprises a non-transitory, computer-readable medium comprising computer instructions that, when executed by at least one processor, are adapted to a cause an image captured by the camera to be displayed on a mobile device, and to control airflow onto at least a portion of the window.

In at least some implementations, there is provided a method for monitoring snow or ice accumulation on a vehicle window by a user with a mobile device. The method comprises directing a camera toward a portion of a vehicle window to capture an image of the portion of the window. The method further comprises providing the image to a mobile device. The method further comprises controlling a blower to direct airflow over the at least a portion of a vehicle window to clear the at least a portion of a vehicle window of snow or ice.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2. is a diagrammatic plan view of a vehicle;

FIG. 3 is a diagrammatic view showing a mobile device and vehicle; and

FIGS. 4a, 4b and 4c are diagrammatic illustrations of a windshield in various stages of clearing snow or ice as can be depicted on the screen of a mobile device.

### DETAILED DESCRIPTION

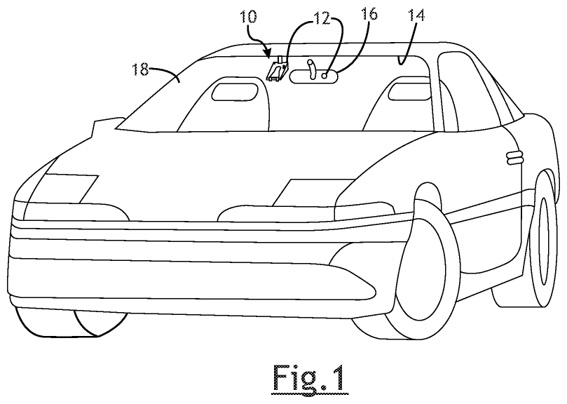

The figures generally show a system 10 for monitoring snow or ice accumulation on a vehicle window. As best seen in FIG. 1 the system 10 includes a camera 12. The camera 12 can be mounted in the interior of the vehicle at any suitable location. By way of example, the camera can be mounted in a housing that depends from the roof 14 of the vehicle. The camera 12 could alternatively be mounted on or in the housing for a rearview mirror 16. It will be appreciated, however, that the camera 12 can be mounted in any suitable location in the vehicle that allows the camera to have a view of all or a portion of a vehicle window 18.

In at least some implementations, the camera 12 is adapted to be directed toward a vehicle window 18 so that a field of view of the camera 12 includes at least a portion of the vehicle window 18. That is, the camera 12 is positioned so as to allow the camera to capture an image of at least a portion of a widow 18. In an implementation, the camera 12 is positioned in a way to capture an image of the entire window 18, such as a windshield.

In other implementations, the camera 12 may be positioned in the vehicle so as to capture images of a window 18 that is different from the windshield. By way of example, the camera may be positioned to capture images of all or a portion of one or more side windows or all or a portion of a rear window. Furthermore, in yet other implementations multiple cameras 12 may be used to capture images of multiple windows.

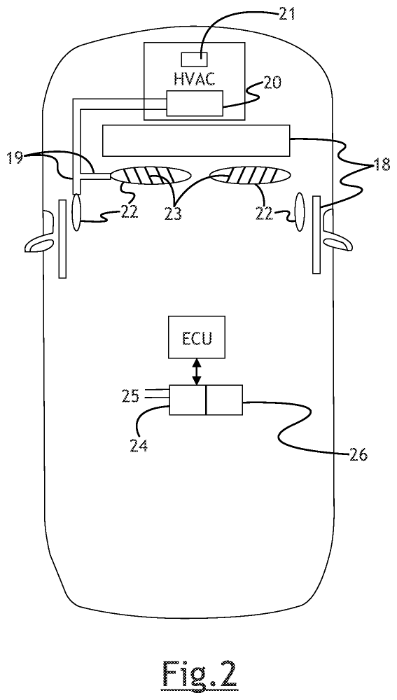

As best shown in FIG. 2, the system 10 further comprises a blower 20 adapted to blow air onto one or more of the vehicle windows 18. The blower 20 may comprise the fan and blower motor of a vehicle's HVAC system. The HVAC system also includes a heating element 21 which may heat air flowing thereover to provide heated air to the blower 20. Controlling the heating element 21 allows the temperature of the air flowing to the blower 20 to be adjusted. In an implementation, the blower 20 is coupled with vents 22 through ducting, 19. The vents 22 are adapted to direct the airflow from the blower 18 onto the respective window 18 or portion thereof. In an implementation, the vents 22 may contain moveable louvres 23 that can be adjusted direct the airflow from the blower 20. The louvres 23 can be adjusted to direct the airflow onto all or a portion of the window with greater control of where the air will flow.

The system further comprises one or more processors 24, and memory 26. In at least some implementations, a “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions. In at least some implementations, the one or more processors may be any suitable electronic processor, such as: x86/x86-64 processors, such as Intel™ Core series and AMD Ryzen™ series, widely adopted in the personal computing domain; or ARM processors, such as Qualcomm Snapdragon™, NVIDIA Tegra™, and Apple M1™ processors, common for mobile and embedded systems. In order to perform the prescribed functions and desired processing, as well as the computations therefore, controllers or processors 24 may include, but are not limited to, a processor(s), computer(s), DSP(s), memory, storage, register(s), timing, interrupt(s), communication interface(s), and input/output signal interfaces, and the like, as well as combinations comprising at least one of the foregoing. For example, controllers and processors 24 may include input signal processing and filtering to enable accurate sampling and conversion or acquisitions of such signals from communications interfaces. It will be appreciated that these are examples, as other electronic processors may be used.

The memory 26 further comprises a non-transitory, computer-readable medium comprising computer instructions that is implemented as a non-volatile computer data storage device, such as, for example, ROM (read-only memory), solid-state drives (SSDs) (including other solid-state storage such as solid-state hybrid drives (SSHDs)), other types of flash memory, hard disk drives (HDDs), magnetic or optical disc drives, non-volatile random access memory (NVRAM), etc.

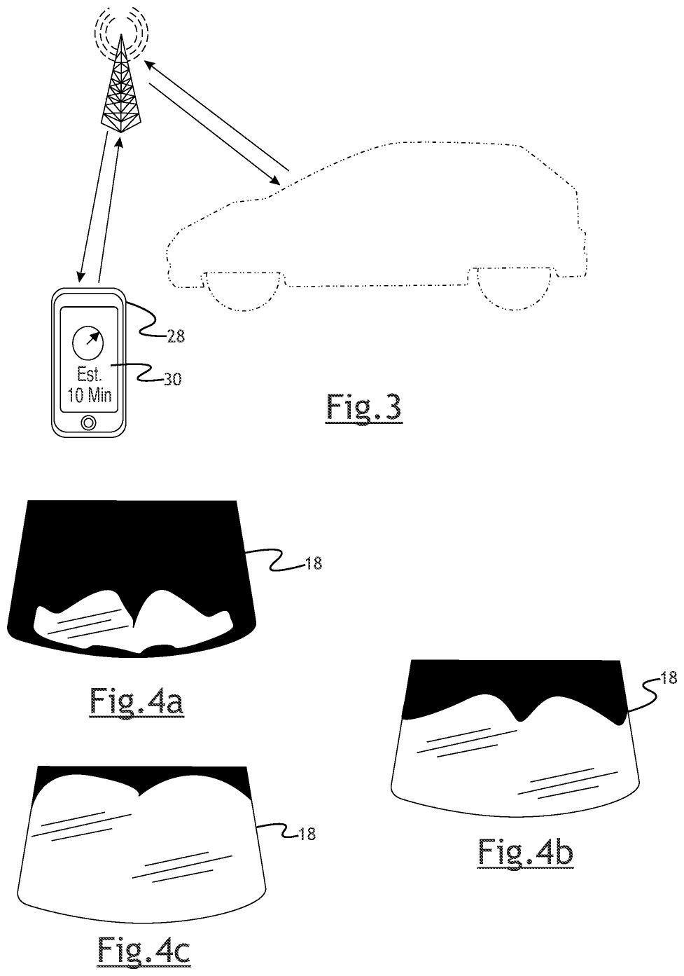

As depicted, for example in FIG. 3, the system 10 also communicates with a mobile device 28. The mobile device 28 may comprise a wireless communications device which is an electronic device that is used for carrying out wireless communications, such as cellular carrier communications (or other long-range wireless communications) and/or dedicated short-range communications (DSRC) (e.g., Wi-Fi™, Bluetooth™) (or other short-range wireless communications). In implementations, the mobile device 28 is implemented as a telematics unit and includes a cellular chipset used for cellular carrier communications, such as for communicating with an end point through use of cellular infrastructure. In other implementations, the mobile device 28 includes DSRC circuitry, such as a Bluetooth™ chipset, for communications via DSRC technology. In some embodiments, the mobile device 28 includes both short- and long-range communication capabilities. In an implementation, the mobile device 28 may comprise a smart phone that communicates with the vehicle. The mobile device 28 may contain a mobile application or App. The system 10 can provide signals to the mobile device 28. For example, the system 10 can send and receive signals to or from the mobile device 28 through an application such as Uconnect™. The mobile device 28 may comprise a mobile electronic device, such as a smartphone, tablet or the like. The mobile device 28 may include a screen 30. The user with the mobile device 28 can be located in any location where a signal can be received or sent. The user may advantageously start the system 10 using the mobile device 28 to send a signal to the vehicle ECU from the location of the user.

The computer instructions, when executed by the at least one processor 24, are adapted to a cause an image captured by the camera 12 to be displayed on the screen 30 of the mobile device 28. The image captured by the camera 12 comprises at least a portion of the window 18. The displayed image can be viewed by a user on the mobile device 28 to provide an indication of how much snow or ice remains on the window 18. The same displayed image also depicts areas of the window 18 that have been cleared of snow or ice. FIGS. 4a-4c depict representations of a window 18 as may be displayed on the screen 30 of the mobile device 28. FIG. 4a depicts the least amount of snow or ice having been cleared. FIG. 4b depicts an example of an intermediate amount of snow or ice having been cleared. FIG. 4c depicts an example of most of the snow or ice having been cleared.

The computer instructions when executed by the at least one processor 24, are further adapted to control the blower 20 to thereby control the airflow to at least a portion of the window 18 through the vents 22. In some implementations, the vents 22 may contain moveable louvers 23. The louvers 23 may be adjusted by the user of the mobile device 28 in order to direct the airflow onto a desired part of the window 18 to be cleared. More specifically, upon input from a user, the computer instructions when executed by the at least one processor 24, may adjust the louvers 23, such as by commanding a motor that is coupled to the louvers 23 to move the louvers. Furthermore, the computer instructions when executed by the at least one processor 24, may control the temperature of the airflow to the blower 20.

In an implementation, the computer instructions that, when executed by at least one processor 24, are further adapted to calculate an estimated amount of time necessary to clear at least a portion of the window of snow or ice accumulation. More specifically, the processor 24 can receive one or more signals at inputs 25 relating to the weather and/or the amount of snow and ice accumulated on the window 18. The signals can represent, for example, the amount of snow or ice on the window 18 as may be detected by the camera 12, an outside temperature, and/or a weather report or forecast. The signals may also represent the temperature of the airflow emanating from the heating element 21, the velocity of the airflow and/or the position of louvres 23 in the vents 22. The computer instructions, when executed by the processor 24 can process the signals input to the processor to calculate the estimated amount of time necessary to clear some or all of the window 18. The calculated time can be provided to the mobile device 28 and can be displayed on the screen 30 for the user, as can be seen in FIG. 3. In this way, a user can be provided with the estimated time to clear the window 18 and can, if desired, go to the vehicle about the same time as or after the estimated time to all the user to minimize the user's time in the cold.

The computer instructions that, when executed by at least one processor 24, are further adapted to detect when sufficient clearing of the snow or ice has been achieved. A signal can be generated and sent to the mobile device 28 for display on the screen 30 indicated that sufficient snow or ice has been cleared. FIG. 4c shows an example of when a sufficient amount of snow or ice has been cleared. Furthermore, in an implementation, if it is detected that a part of a window 18 has been cleared, but the other parts of the window 18 have not been cleared, a signal indicative of this condition can be sent to the processor 24. The computer instructions when executed by the processor 24 may then control the airflow by directing it to a portion of the window 18 needing further clearing. This may result in more efficient clearing and spot clearing of the snow and ice. In this way, a feedback system may provide feedback from the camera 12 signal to control at least one of the heating element 21, blower 20 speed or direction of the airflow which may include adjusting the louvers 23. It will also be appreciated that a user can select the portions of the window 18 to be cleared by making inputs in the mobile device 28 that is coupled with the processor 24. The processor can receive such inputs and execute the clearing of the portion of the window 18 as directed by the user.

In addition, computer instructions that, when executed by at least one processor 24 may send a signal to the vehicle ECU to shut down a vehicle engine or batteries of an electronic vehicle if a predetermined amount of time has lapsed after detection of sufficient clearing of the snow or ice. In this way, fuel can be saved by not running the engine for a period of time. It will be appreciated that the signal to shut down the vehicle engine or batteries may be simultaneous with the detection that a sufficient amount of snow or ice has been cleared. Furthermore, the signal to shut down the vehicle engine or batteries may occur prior to the detection of sufficient clearing of the snow or ice. This may be helpful when a predetermined amount of time has passed, and the sufficient snow or ice has not been detected to prevent overuse of the vehicle engine or batteries. Such a signal may also be delivered to the engine control in the event an anomaly, unrelated to the clearing of snow or ice, has been detected to avoid damaging the vehicle engine or batteries. In addition, a user of the mobile device 28 may send a signal to the processor 24 to shut down a vehicle engine or batteries.

According to an implementation, a method for monitoring snow or ice accumulation on a vehicle window by a user with a mobile device 28 is provided. The method comprises directing a camera 12 toward at least a portion of a vehicle window 18 to be cleared to capture an image of the portion of the window 18 which may be covered by snow or ice. The image can be provided to a mobile device 28 which can be displayed on the screen 30. This provides a user of the mobile device 28 with an image depicting the amount of snow or ice on the window 18.

The method further comprises controlling blower 20 by at least one of controlling the direction of airflow from the blower 20 or the velocity or flow rate of airflow from the blower 20. Furthermore, the method includes controlling the temperature of the airflow from a heating element 21 that is directed to the blower 20. It will be appreciated that the controlling of the blower 20 or the temperature of airflow directed to the blower 20 can either be controlled by a user of the mobile device 28 who can make an input on the mobile device 28 which in turn provides a signal to the processor 24. Additionally or alternatively, the controlling of the blower 20 can be carried out by the processor 24 based, at least in part, on the input signals received from the camera 12 as well as the temperature of the airflow, the speed of the airflow from the blower 20 and/or the positioning of the louvres 23, or the vent 22 through which the airflow is directed.

The method further comprises providing a non-transitory, computer-readable medium comprising computer instructions that, when executed by at least one processor, calculates an estimated amount of time necessary to clear at least a portion of the window of snow or ice accumulation and providing a signal to the mobile device representing the estimated amount of time. As set forth above, the processor 24 can receive one or more signals. The signals can represent, for example, the amount of snow or ice on the window 18 as may be detected by the camera 12, an outside temperature, and/or a weather report or forecast. The signals may also represent the temperature of the airflow emanating from the heating element 21, the velocity of the airflow and/or the position of louvres 23 in the vents 22. The computer instructions, when executed by the processor 24 can further process the signals input to the processor to calculate the estimated amount of time necessary to clear some or all of the window 18. The calculated time can be provided to the mobile device 28 and can be displayed on the screen 30 for the user.

The method further comprises detecting when sufficient clearing of the snow or ice has been achieved. The sufficiency of the clearing can be determined in any suitable manner; by way of example, the clearing can be determined by processing the image form the camera and comparing the amount of clearing of snow or ice that has occurred with a predetermined amount of the window 18 to be cleared of snow or ice. Alternatively, in other implementations, the user can set a predetermined amount of the window 18 that is sufficient for the user's purposes. Once detected, a signal can be generated and sent to the mobile device 28 for display on the screen 30 indicating that sufficient snow or ice has been cleared. Furthermore, in an implementation, if it has been detected that a part of a window 18 has been cleared, but the other parts of the window 18 have not been cleared, a signal representing this can be directed to the processor 24 as well as to a screen 30 on the mobile device 28. Then, the computer instructions when executed by the processor 24, may control the airflow to a portion of the window 18 needing further clearing. This control may include any or all of the adjusting the temperature of the airflow from the heating element 21, the velocity of the air from the blower 20, the vent 22 through which the air flows and the position of the louvres 23. This may result in more efficient clearing and spot clearing of the snow and ice. In this way, a feedback system may provide feedback from the cameral 12 signal to control at least one of the heating element 21, blower 20 speed or direction of the airflow which may include adjusting the louvers 23. It will also be appreciated that a user can select the portions of the window 18 to be cleared by making inputs in the mobile device 28 that is coupled with the processor 24. That is, the processor 24 can receive such inputs and execute the clearing of the portion of the window 18 as directed by the user of the mobile device 28. For example, the mobile device user selects an area of the vehicle window 18 to be cleared and provides a user input to the mobile device 28 to send a signal to the at least one processor 24 representing the area of the vehicle window to be cleared.

In some implementations the method further comprises the sending of a signal to turn off the vehicle, such as by shutting down the engine or batteries of an electronic vehicle if a predetermined amount of time has lapsed after detection of sufficient clearing of the snow or ice. In this way, fuel can be saved by not running the engine for too long of a period of time. Similarly, battery charge may be saved by shutting down the batteries upon sufficient clearing of the snow or ice by not continuing to draw energy from the batteries. In addition, a user of the mobile device 28 may send a signal to the processor 24 to turn of the vehicle.

Some implementations described herein relate to a forward-facing camera 12 for detection of snow or ice on the front window 18 or windshield. It will be appreciated that any number of cameras 12 may be used in other implementations, which cameras may be directed to any or all of the windows 18 in a vehicle. In this way, any or all of the windows 18 and any or all portions of the windows 18 may be cleared. Furthermore, some implementations described herein relate to the clearing of snow or ice from the windows 18. It will be appreciated that snow or ice or other condensed moisture may be cleared from the windows 18 within the scope if the implementations described.

What is claimed is:

1. A system for monitoring snow or ice accumulation on a vehicle window comprising:
a camera adapted to be directed toward a vehicle window and adapted to view at least a portion of the vehicle window, and adapted to capture images of the vehicle window;
a blower adapted to blow air onto the vehicle window;
a non-transitory, computer-readable medium comprising computer instructions that, when executed by at least one processor, are adapted to
a) cause an image captured by the camera to be displayed on a mobile device and;
b) control airflow onto at least a portion of the vehicle window.

2. A system for monitoring snow or ice accumulation on a vehicle window as set forth in claim 1 wherein the computer instructions that, when executed by at least one processor, are further adapted to calculate an estimated amount of time necessary to clear at least a portion of the vehicle window of snow or ice accumulation.

3. A system for monitoring snow or ice accumulation on a vehicle window as set forth in claim 2 wherein the estimated of time necessary to clear the vehicle window of snow and ice is at least partly based on at least one of a coverage area of the snow or ice on the vehicle window, an outside temperature, a weather report, or a weather forecast.

4. A system for monitoring snow or ice accumulation on a vehicle window as set forth in claim 1 wherein the computer instructions that, when executed by at least one processor are further adapted to provide a signal to the vehicle to turn off a vehicle engine after detecting that the vehicle window has been cleared of snow or ice.

5. A system for monitoring snow or ice accumulation on a vehicle window as set forth in claim 1 wherein the camera is directed toward the windshield of a vehicle and is adapted to capture images of the entire windshield.

6. A system for monitoring snow or ice accumulation on a vehicle window as set forth in claim 1 further comprises at least one vent coupled to the blower through which airflow can be provided and directed to at least a portion of the vehicle window.

7. A system for monitoring snow or ice accumulation on a vehicle window as set forth in claim 6 wherein at least one vent comprises moveable louvres, and wherein the louvres can be moved to direct the airflow through the at least one vent to at least a portion of the vehicle window.

8. A system for monitoring snow or ice accumulation on a vehicle window as set forth in claim 7 further comprising a heating element coupled with the blower and the computer instructions that, when executed by at least one processor are further adapted to control the heating element to adjust the temperature of the airflow to the blower.

9. A system for monitoring snow or ice accumulation on a vehicle window as set forth in claim 1 wherein the camera is directed toward at least one of a rear window or a side window, and the camera is adapted to capture images of at least one of a rear window or a side window.

10. A method for monitoring snow or ice accumulation on a vehicle window by a user with a mobile device comprising:
directing a camera toward a portion of a vehicle window to capture an image of the portion of the vehicle window;
providing the image to a mobile device; and
directing the airflow to at least a portion of a vehicle window to clear the at least a portion of a vehicle window of snow or ice.

11. The method set forth in claim 10 further comprising controlling the airflow by controlling at least one of the velocity of airflow from a blower, the direction of airflow through a vent coupled with the blower, or controlling the temperature of the airflow from a heating element coupled with the blower.

12. The method set forth in claim 10 further comprising providing a non-transitory, computer-readable medium comprising computer instructions that, when executed by at least one processor, calculates an estimated amount of time necessary to clear at least a portion of the vehicle window of snow or ice accumulation and providing a signal to the mobile device representing the estimated amount of time.

13. The method set forth in claim 10 wherein the at least one processor receives at least one signal and where in the at least one signal represents at least one of an amount of snow or ice on the vehicle, an outside temperature, a weather report or a weather forecast.

14. The method set forth in claim 10 further comprising generating a signal when the computer instructions that, when executed by at least one processor, upon determining that the vehicle window has been cleared of snow or ice and providing the signal to a mobile device user.

15. The method set forth in claim 14 wherein a mobile device user provides a user input to the mobile device to send a signal to the at least one processor to shut down a vehicle engine or batteries.

16. The method set forth in claim 10 wherein the airflow is directed by moving louvres.

17. The method set forth in claim 10 wherein a mobile device user selects an area of the vehicle window to be cleared and provides a user input to the mobile device to send a signal to the at least one processor representing the area of the vehicle window to be cleared.
